(19) United States
(12) Patent Application Publication
(10) Pub. No.: US 2011/0047610 A1
(43) Pub. Date: Feb. 24, 2011

(54) Modular Framework for Virtualization of Identity and Authentication Processing for Multi-Factor Authentication

(75) Inventors: Ramana Murty Mylavarapu, San Jose, CA (US); Shivaram H. Mysore, Saratoga, CA (US)

Correspondence Address: FERNANDEZ & ASSOCIATES, LLP, P.O. BOX D, MENLO PARK, CA, 94026, US

(73) Assignee: KEYPAIR TECHNOLOGIES, INC., Santa Clara, CA (US)

(21) Appl. No.: 12/543,682

(22) Filed: Aug. 19, 2009

(51) Int. Cl. G06F 17/00

(52) U.S. Cl. 726/12

(57) ABSTRACT

Identity access appliance works in conjunction with the edge network devices and provides the necessary protocol authentication, user authentication statement, authorization summary and its attributes. Besides authentication these appliances protect the infrastructure against intrusions such as possible authentication vulnerabilities, authentication connection attacks, denial of service attacks, spam and scanning/hacking the credentials, in a short span of time and generate real time alerts, statistics and reports.

### FIELD OF INVENTION

The present invention relates to authentic an of client credentials for accessing services over a network.

### BACKGROUND OF INVENTION

Network devices, such as routers and gateways, provide access to secure networks comprising of segments of host systems/devices and systems/devices in public network through Internet. Firewalls in the network device help in protecting the internal networks against commonly found attacks in L3, L4 and some applications.

Identity authentication and authorization as part of access devices and in some cases at the actual application server is widely used technique. This involves identifying the services that need authentication and making the user/access device to provide the identity and/or credentials and allow the access to the service(s) after authentication. This function of authentication at the access device has always been an ancillary function in these network devices and beyond authentication these devices will not able scale to address any of the above mentioned functionality. Primary reason is that it reduces the throughput performance of these devices/application servers and thereby the authentication techniques and detection scenarios are limited and incomplete.

### SUMMARY OF INVENTION

Identity Access method described in this invention greatly improves the performance of the authentication systems without having to depend on hardware accelerator completely. The packets go through processing stages such as protocol classification, policy/decision engine, intrusion detection, session/connection management and protocol authentication by avoiding redundant processing, memory and IO accesses. Configuration of processing rules are classified and divided into multiple hierarchical records, based on the parameters such as direction of traffic, application type, application date type, service being accessed, protocol stage, etc.

The protocol classification modules are fine-tuned to perform in-line vulnerability checks, preprocessing on the packet before searching to detect the patterns. Further session and rule/pattern search techniques through configurable hierarchy makes the first packet process really fast. Session and transaction sanity against replay attacks, denial of service attacks, etc are through content addressable techniques and prevents the attack in real time and does not allow proceed down the lane of the packet flow.

Authentication process acceleration achieved through multi-layered and multi-processing architecture in software.

The processing layers called adaptation layers contain adapters for specific functionality. The adaptation layers perform distributed processing and they are named based on the function.
1. Transport Adaptation Layer,
2. Protocol Classification Adaptation Layer,
3. Protocol Authentication Adaptation Layer
4. Authentication Server Adaptation Layer.

These Adaptation Layers contain adapters that perform protocol/application specific processing. They interact with the Core Processing Engine. Core Engine performs the Session/Transaction Management as per the policies that define the authentication processing flows.

The adapters of the layers process the authentication requests in a collaborated way by communicating among themselves through a messaging layer. These activities are called module services. The messaging layer enables zero latency in the communication between two modules. It also makes the interactions to be concurrent and multiple adapters can get the services of another adapter in parallel.

Enhanced session and transaction management is achieved through hierarchical session organization. Sessions are created using multi-stage hashing. Each hash stage contains keys for hashing. These keys are dynamically configurable as needed to make session organization based on configurable classification parameters.

The classification parameters also include the parameters that enable virtualization. These parameters are extracted from the authentication request generated by the protocol classifier. They include requested enterprise, packet direction, risk level, secure source network, provider or enterprise, application/service type, application data type, domain, service/resource requested, etc. Authentication processing policies or rules are maintained in a hierarchy similar to the session hierarchy.

Virtualization of authentication request processing is achieved on one or more relevant classification parameters above by organizing the rules based on the virtualization parameters and mapping them to transactions.

Virtualization is extended to services such as authentication request processing, rate limiting policy enforcement on number of transactions per second, maximum concurrent transactions etc., for each entity.

Ultra fast transaction look up through content addressable transaction look up. A session represents a service/resource in a given domain. Under a session a transaction gets added when an authentication request is received for that. The request is identified using a unique identifier. The request and response are correlated without performing session look up. The authentication challenges are by tagged with an encrypted session parameters token (SPT) which embeds session handle, transaction handle, unique identifier of the requesting source, sequence number, etc. This mandates the subsequent authentication responses from the principal to bear the SPT token. The session manager is immune to replay attacks and tampering of this token as the token is encrypted. The SPT provides one step authentication to reach the transaction in question.

Authentication request flooding/connection flood attacks are countered though intelligent session management.

### BRIEF DESCRIPTION OF DRAWINGS

FIG. 1 is a diagram illustrating the relationship of the gateway with respect to the clients with requests to be authenticated and applications providing resources and services, also the major components of the gateway pertinent to the function of authenticating requests.

FIG. 2 is a diagram illustrating the major modules of session manager.

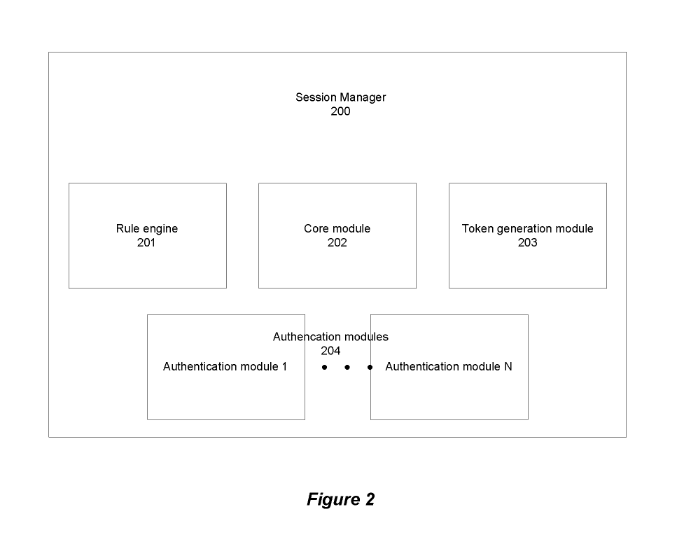

### DETAILED DESCRIPTION

The gateway receives messages/requests from clients/devices requesting services controlled by said gateway. The messages/requests comprise packets or packet data units. The gateway authenticates the messages/requests and sends back the response packets or packet data units. An authentication processing flow, which is also called application flow, is comprised of such request packets or packet data units and response packets or packet data units. In this method of authentication processing the messages of each application flow are received by the gateway which sends clients/devices correlated response as responses through authentication sessions. These sessions enable the gateway to process the present application flow as well as the application flows associated with the session at later point of time. This method is called stateful authentication process.

The gateway process the each application flows according to the processing rules depending on a subset of the characteristics of each application flow. This subset of characteristics is called virtualization parameters. Processing rules are defined for each unique combination of virtualization parameters. These parameters are extracted from various layers of the IP packet received. Virtualization parameters are configurable as per the deployment of the gateway. They may include: packet source, source logical network name, service provider ID, enterprise ID, preceding network element ID such as a load balancer, an application delivery controller, a router, etc. The module that performs the extraction operation of the virtualization parameters is called protocol classifier. There is one protocol classifier for each type of application or service.

Session and rules are organized in the gateway in a hierarchical way. There is a session hierarchy and a rule hierarchy. Within the hierarchy, the sessions and rules are organized by sets of parameters called session classification parameters and rule classification parameters respectively. Protocol classifier besides extracting the virtualization parameters, extracts these parameters from the various layers of IP packet.

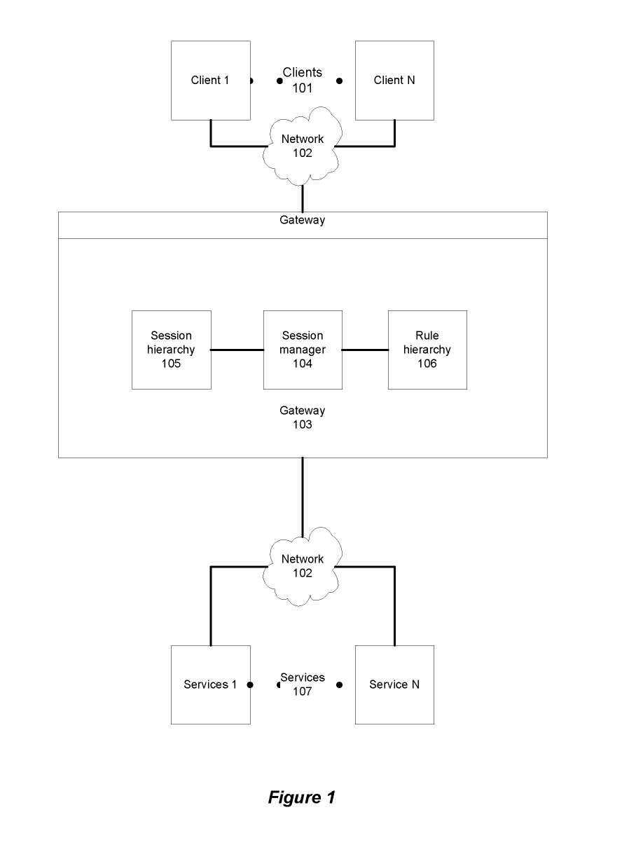

FIG. 1 shows the relationship between the network objects comprising clients, services, and the gateway and also the components of the gateway relevant to this invention. The solid lines between the components and objects represent data/messages flow between them.

The rule hierarchy contains multiple rule hierarchy instances. A rule hierarchy contains a rule hierarchy instance of rules for every unique set of virtualization parameters of a processing. Subjugate to a rule hierarchy instance, an application type node for each application or service specified in the processing rule is created. A subjugate application data type node to the application type node for each application data type specified in the processing rule. The application includes various L4 to L7 applications, application data type includes data types used in the application Protocol Data Unit (PDU), application server domain being accessed and service or the base path and resource being accessed in the server. These parameters called as session classification parameters are extracted from the IP Packets received in the application flow.

Rule nodes are the leaf nodes in the rule hierarchy. A rule node contains rule summary and any optional parameters in addition to the rule classification parameters needed for processing the application flow messages. These parameters include: rate limits on the application flows belonging to the rule, source IP or source sub-network of the client/device and any other parameters that are extracted by the protocol classifier from the IP packet. Where rate limits define the maximum number of application flows at any point of time that are allowed through the session created with this rule, maximum number of application flows in a second of time that are allowed through the session created with this rule. A rule summary contains parameters needed for processing the application flow messages. These parameters include: rule action to allow or deny the application flow, protocol authentication needed for the application flow, risk level of the application flow.

Session manager maintains the sessions in the authentication flow. Session manager comprises the rule engine, a plural of protocol authentication modules, session manager core module and token generator module. The major functions performed by the session manager and its subjugate modules are authentication processing for incoming messages or requests, transaction time out processing, rule lookup processing by the rule engine, and generating the Session Parameter Token (STP) by the token generator module. Session manager can also handle several types of attacks.

On receiving a message, an inspection of the type of request or message determines the course of actions taken by the session manager to authenticate the request or message. The course of action can be initial request authentication processing or subsequent request authentication processing.

Each application flow considered for authentication processing results in a transaction under the session. A transaction represents an application flow that is being processed by the session manager. A transaction comprises the rule summary, UUID of the application flow, encrypted session parameter token (SPT), protocol authentication state transition details and the associated information such as state timeout, authentication challenge information.

The steps used by the session manager for initial request authentication processing are:
1 For an initial request, the request is sent to the rule engine for rule look up processing. This rule engine is a component of the session manager.
2 If the rule summary is to allow the application flow then lookup for virtualization parameters in the virtualization parameter hash table is performed. If there is no entry for the set of virtualization parameters of the message, then a new node is added to the virtualization hash table for the unique virtualization parameters in the session hierarchy. The session classification parameters are hashed and an entry/node is made in the session classification parameter hash table. This node is called session node.
3 If an entry is found for the virtualization parameters in the virtualization parameter hash table, then look up is made for the session classification parameters in the session classification parameter hash table. If a node is not found an entry of session node is made in the hash table.
4 To the session node a transaction node is added for the application flow being processed.
5 Rate limiting on the number of sessions and transactions is performed while adding a new session/transaction as follows based on the rate limiting parameters configured in the rule summary for that application flow.
6 Cumulative number of sessions of the application flow shall be less than the maximum number of sessions allowed.
7 Cumulative number of transactions of a session shall be less than the maximum number of transactions allowed.
8 Number of transactions in 1 sec shall be less than the maximum transactions per second.
9 If the limit is reached for any of the criteria above, then the session/transaction is not added as the case may be a flooding attack and the client/device is responded with error code indicating the limits reached, and the client/device is advised to resend the request later.
10 The transaction node so created is updated with the session node handle and rule summary. The transaction node is further updated with UUID (Universal Unique Identifier) identifying the client/device. This UUID is generated by the token generator module. A session parameter token (SPT) is then created with the help of token generator module and updated in the transaction node. The SPT contains transaction handle, session handle, session classification parameters and virtualization parameters.
11 The application flow message along with the transaction handle is sent to protocol authentication module specified in the rule summary for further processing the message. The protocol authentication module updates the transaction with the states of authentication processing at every state.

The steps taken for subsequent request authentication processing are:
1 A subsequent request message contains a session parameter token (SPT).
2 Session manager validates the request by sending the SPT to the token generator to check its integrity.
3 If the SPT timed out or the integrity check could not be done then it will be treated as a stale SPT and the request is considered as a new request and processes the request as per the initial request processing.
4 If the SPT is found to be tampered, then it will be treated as an attack and necessary syslog message is generated.
5 Upon validation of SPT, the transaction is validated as follows.
6 Transaction handle's UUID and message sequence are validated against session params UUID and message sequence.
a. Session handle is validated against the session handle pointed by the transaction handle.
b. The session classification parameters are compared with the packet parameters
c. The virtualization parameters are compared with the packet/message parameters.
7 If any of these validations fail then necessary syslog messages are generated for various replay attacks. The request is considered as a new request and processes the request as per the Initial Request Processing.

Session parameter token securely identifies an application flow that is currently being authenticated. It comprises of the following information: session handle, transaction handle, universal unique identifier (UUID), message sequence, integrity code. Session handle refers to session to which the application flow belongs to. One session for all the application flows associated with it. Transaction handle refers to transaction of the application flow being authenticated. UUID is a unique identifier the gateway assigned to the user or device for that application flow. A universally unique identifier (UUID) which is also known as GUIDs (globally unique identifier) is a uniform resource name (URN) namespace. A UUID is 128 bits long, and can guarantee uniqueness across space and time. UUIDs were originally used in the Apollo Network Computing System. It is specified in IETF RFC 4122. Message sequence is message ID of the response that was sent by the gateway. This parameter of SPT is used to correlate the subsequent message received from the client or device with the message that was sent before processing it. This parameter besides providing the correlation between the application state and the message, by incrementing the sequence number every response message provides security for SPT replay attacks. Integrity code is a cryptographic checksum used to authenticate rest of the SPT parameters. Cryptographic hash function Secure Hash Algorithm-2 (SHA-2) with a 128 bit secret is used for generating the checksum.

Transaction timeout processing by the session manager include the following steps,
1 Transaction timeouts are state driven and the protocol authentication module processing the application flow of a transaction sets the timeout period for every state transition.
2 At a configured granularity of time interval, transactions of each session are checked for their timeouts. If a transaction times out the corresponding protocol authentication module specified in the rule summary is notified. The protocol authentication module processes the event based on the state of the transaction. The actions taken by the protocol authentication module may include deletion of transaction.
3 When there are no more transactions in a session then the session is deleted.

The rule engine takes the following steps to perform rule lookup processing
1. Rule engine takes as input the virtualization and rule classification parameters. These parameters are extracted by the session manager from the application flow message.
2. Virtualization parameters are looked up in the virtualization parameter hash table for a unique set of parameters. If there is no entry, then it is treated as an application flow rule look up failure. Look up process terminates and application flow rule look up failure is sent back to the session manager.
3. If Virtualization parameter look up succeeds then lookup for rule classification parameters in the rule classification hash table is made. If there is no entry, then it is treated as an application flow rule look up failure. Look up process terminates and application flow rule look up failure is sent back to the session manager.
4. Further the rule node parameters are matched with the application flow parameters. If all the rule node parameters match, then the success rule look up response along with rule summary is sent to the Session manager for further processing of the initial request.

Session manager has the ability to handle certain types of attacks. Session manager needs to distinguish between genuine requests and replay attacks thereby ensuring proper functioning of the authentication appliance. Another common form of attack is L7 (application layer) flooding attack; wherein an attacker uses genuine requests repetitively to try flood the authentication appliance. The procedure to handle these attacks follows:
1 Session manager provides tunable parameter for maximum number of transactions for each session.
2 When the appliance is under L7 flood attack, its transaction buffers whose sizes is tunable, are full and it cannot handle application flows beyond that point.
3 So when the number of transactions reach a threshold of 70% of the maximum number of transactions, Session manager does not create a transaction, while handling application flow messages; instead it does the following:
4 Session manager, using token generator module, generates a session parameter token (SPT) with different contents. This SPT is called hollow SPT (HSPT). The HSPT comprises of the following information: Session handle, source IP address of the client or device, source port of the client or device, message sequence number and integrity code.
5 Protocol authentication module processes the request without a transaction. And the SPT/HSTP is returned to the client to be stored as cookie.
6 When the client responds back, it shall be providing the session parameters in the cookie and the credentials.
7 When the response is received, session manager gets the session parameters validated by token generator. If the digest is valid then it checks the source IP address of the message and session parameter. Both shall be same. The source port can be different for each response.
8 If the session parameters digest is invalid, then it is tampering of session parameters. No response is sent. Generate a system log.
9 If the digest is correct but the source IP address is changed in the response message, then it is an attack. Then no response is sent. Generates a system log.
10 If the session parameters are valid then goes to the session using the session handle in the session parameters. If the response contains credentials, it then validates the remainder of the application flow, namely: session classification parameters and virtualization parameters. If they match then it will be treated a genuine response and a transaction is created. Also, the session manager, using token generator module, generates session parameters with session handle, transaction handle, unique ID, etc as usual and send the STP to the client for subsequent response handling.
11 If the session classification parameters or virtualization parameters do not match then appropriate system log message for the attack is generated as usual and response is dropped.
12 If the response does not contain credentials, then it will still be viewed as L7 flood attack. Generates new session parameters by incrementing the sequence number (seq. number) and updating the source port. Generate a system log.
13 Based on sequence number, after the number of attacks reaches a limit, the source IP is blacklisted. The blacklisted source IP addresses are added as nodes in UAST.

Upon successful authentication of an application flow, an association between the client or device and the gateway is established. This association is called a binding. The client or device is expected to present this binding in all its subsequent application flows for the authenticated application glow and for different application flows. Thus, a binding is the credential the client or device established before the gateway and such credential should be presented by the client or device whenever subsequent communication with the gateway is conducted. For example, a binding in an http application flow is cookie.

Binding also refers to the association between the client or device and application server maintained in the gateway. This binding is a token that is issued by the gateway to the application server upon authenticating the application flow.

The gateway performs life cycle management of the bindings upon successful authentication of an application flow using a module called user authentication status table (UAST).

The UAST maintains the relational information of the user authentication session for various application flows. This information is organized in the memory as data structures and externally as tables for backup purposes.

These data structures contain one parent node and one or more child nodes related to a parent node in a single hash table. Both parent and child nodes are stored in the hash table and are looked up with their own hash keys.

The parent node contains an authenticated session for a given application flow and includes following information:

Authenticated session information: This information includes virtualization parameters, session classification parameters, authentication attributes and other useful information.
1. Node timeout: A parent node times out after the timeout period of the binding of the client or device or at the end of Kerberos Ticket Get Token (TGT) timeout period if Kerberos TGT is used as binding with the application server.
2. Child node count: This value is the number of child nodes associated with it.
3. Child nodes pointers list: List of Child node pointers that are associated with it.
4. Other information may also be included in the parent node when necessary.

The child nodes are added upon each successful application flow processing and associated with the parent node by way of adding the child node to the child nodes pointers list of the parent node and incrementing the child node count.

The child nodes typically include information about:
1. Binding issued between the client and each application server. These binding are also called service tokens.
2. Client or device user name and host domain for which authentication is performed.
3. Parent node handle.

The look up for the nodes is done by using node selector information. A node selector contains the parameters used as keys for hash generation and look up. This information is specific to the type of node and its usage. The selector information for parent includes: binding between the client or device and gateway and host domain for which the authentication is performed. Child node selector information contains service token or user name and host domain.

The module provides application programming interfaces (APIs) to add, look up, modify, and delete a node given the node selector information.

The UAST module performs node timeout checks as per the timeouts specified for each node. Upon timeout, the module notifies the protocol authentication module that created the node(s) upon successful authentication of an application flow. The protocol authentication module handles the time out event. The event handling may involve deletion of the node(s).

The in-memory data structure updates are replicated in an external data base.

The following describes a methodology where UAST can be used to assist authentication processing flow.
1. Upon processing an application flow successfully, protocol authentication module provides the binding between the client or device and gateway and service token for client or device and application server binding.
2. It then adds a parent node with the binding between client or device and gateway and host domain.
3. It further adds two child nodes one with service token and the other with user name and host domain as node selector information. The service token based child node is needed for enabling look up by host or application server to validate the token that was issued for its genuineness and validity. Child node with user name and host domain is needed to delete the entries of parent node and its child nodes of the user for a given host domain upon de-provisioning a user.
4. When the client or device tries to login for another application server and service with the same binding with gateway, the protocol authentication module looks up for that service in the authorization attributes in the parent node. If it exists, the protocol authentication module issues another binding/service token for the requested service to the application server. It then adds another child node with service token under that parent node.
5. When a child node times out, an event is sent to the protocol authentication module concerned which in turn may delete the child node. This possible deletion is reflected in the parent node by decrementing the child node count and deleting the child node pointer from the child node list. However the parent node remains active even if there are no active child nodes.
6. When a user name node is deleted, then its parent node and associated child nodes are deleted.
7. When a user logs out for a given application server and service, the protocol authentication module would know through the application flow processing or the application server would notify the gateway, it then deletes the child node associated with that service token. The methodology used by the application server to notify the gateway is beyond the scope of this module design.
8. If the client or device tries to access an application of an unauthenticated host domain the parent node look up fails though the binding is valid. Similarly, if the client or device tries to access a service of the host domain that is not included in the authentication attributes, the parent node look up succeeds but the service is not allowed. The user is asked to login and the authentication processing continues.
9. Upon authenticating, protocol authentication module adds a new parent node with the same binding for the host domain authenticated and adds a child node for the Service and use name node as usual. Hence there are multiple parent nodes for each host domain with the same binding.
10. If it is for a service under an existing host domain, it adds a child node for the service token and associates with the parent node.

What is claimed is:

1. A method for transparent authentication for permission to access resources and acquire services available on a computer network, comprising:
providing a hierarchical model of rule organization and session management for stateful authentication processing in a gateway;
wherein the authentication processing flow processes authentication challenge request and response statefully as per the authentication methodology;
wherein the authentication packet processing rules and sessions are organized, looked up and managed hierarchically;
creating a rule hierarchy instance of rules for every unique set of virtualization parameters of a processing;
adding a subjugate application type node for each application or service specified in the processing rule to the rule hierarchy instance;
adding a subjugate application data type node to the application type node for each application data type specified in the processing rule;
adding a subjugate rule node to the application data type node for each combination of application server domain or URL, service and other rule parameters;
creating a session hierarchy instance of sessions for each unique set of virtualization parameters in the IP packet that has a matching rule in the rule hierarchy;
adding a subjugate application node hierarchically to the session hierarchy instance for each application;
adding a subjugate application data type node to the application node hierarchically for each application data type specified in the processing rule;
adding a subjugate session node to the application data type node hierarchically for a plural of combinations of application server domain or URL and the application; and
adding a subjugate transaction node is added to the session node hierarchically for each application flow.

2. The method of claim 1:
wherein the virtualization parameters represent the parameters that enable abstraction of authentication processing by their own processing rules and the sessions.
wherein the virtualization parameters are derived from the application flow and comprise of: packet source, source logical network, service provider, enterprise;
wherein the application type includes various L4 to L7 applications, application data type includes data types used in the application protocol data unit (PDU), application server domain and service or the base path and resource being accessed in the server;
wherein a transaction comprises:
rule summary, a universal unique identifier (UUID) of the application flow, encrypted session parameter token (SPT), protocol authentication state transition details and associated information;
wherein the SPT is an encrypted token containing UUID, transaction handle, its session handle and a sequence number; thereby SPT provides an association between the application flow and transaction node; and
wherein an SPT is generated along with the transaction and sent to the client or device in the responses to the requests from it.

3. The method of claim 1, further comprising:
identifying an application message as an initial request or subsequent request based on the presence of SPT in the application message,
wherein if the message contains SPT it is treated as subsequent request otherwise treated as new request; and
setting the application flow state either as subsequent request or as initial request depending on the result of the previous step.

4. The method of claim 1, wherein addition of a session hierarchy instance or nodes to an existing session hierarchy for an initial request comprise:
receiving a message from the gateway;
extracting from the message a set of virtualization parameters;
searching the rule hierarchy of the message using the extracted virtualization parameters for a matching rule node to process the request;
wherein the rule node primarily comprises the rule summary of work flow which contains a plurality of protocol authentication stages needed;
identifying the session hierarchy by looking up nodes corresponding to session classification parameters are looked up till the session node is found;
adding a new node structure when the session classification parameters are unique and a session node and a transaction node for the flow; and
updating the transaction node with the rule summary.

5. The method of claim 2, wherein the association of application flow and transaction is looked up through content addressing of SPT, the method comprising:
decrypting the SPT in the response from the client or device; and
validating the constituents of the SPT in the transaction node;
wherein gateway mandates the client or device to send the SPT in the subsequent messages to the gateway;
wherein the transaction node is found and referenced without repetitively looking up into the session hierarchy for the session node and transaction node of the response.

6. The method of claim 5, wherein the method of eliminating replay attacks comprises:
making unique the sequence number parameter in the SPT present in every response that is sent by the gateway by incrementing the value;
invalidating the SPT and dropping the IP packet without processing when the same SPT in the IP packet is used a plural of responses; and
providing valid SPT in the response only upon the packet was successfully by the gateway.

7. The method of claim 5, wherein the method of eliminating session hijack comprises:
encrypting the contents of the SPT;
comparing the session classification parameters of the application flow are compared with those of the session upon validating the association between the application flow and transaction through SPT; and
comparing the virtualization parameters upon success of the above validation.

8. The method of claim 4, wherein based on the protocol authentication work flow in the rule summary of a transaction, the method of conducting the transaction comprises:
creating a binding upon protocol authentication steps among the client or device, gateway and application server for a given application flow the client or device;
deleting the transaction; and
storing the bindings virtualization parameters, session parameters and authorization attributes in the gateway securely.

9. The method of claim 8, the method to avoid subsequent requests going through repetitive authentication work flows comprises:
wherein for same authenticated application flow or new application flows the gateway mandates the client or device to send the binding in the message;
creating a new transaction and setting application flow state to initial request and rule look up is performed;
retrieving the binding from gateway;
validating the retrieved binding against all the application flow virtualization parameters and session parameters;
determining if the application flow is for another application or service that is present in the authorization attributes;
issuing a binding for the application flow when the application flow is authorized;
authenticating the application flow through the full authentication flow when the application flow is not authorized when the application flow misses part of authorization attributes or there is no entry of the binding in the binding store; and
updating the binding entry in the binding store by adding the new binding as a child to first binding representing the binding between the client or device and the application server by keeping the binding between the client or device and gateway the same.

10. The method of claim 9, further comprising:
performing life cycle management of the bindings and bindings timeout as specified by the authentication session timeout interval;
generate time out events when time out occurs; and
publish generated timeout events.

11. A computer-readable medium carrying one or more sequences of instructions for transparent authentication for permission to access resources and/or to acquire services available on a computer network, wherein execution of the one or more sequences of instructions by one or more processors causes the one or more processors to perform the steps of:
providing a hierarchical model of rule organization and session management for stateful authentication processing in a gateway;
wherein the authentication processing flow in an gateway processes the authentication challenge request and response statefully according to the authentication methodology;
wherein the authentication packet processing rules and sessions are organized, looked up and managed hierarchically;
creating a rule hierarchy instance of rules for every unique set of virtualization parameters of a processing;
adding a subjugate application type node for each application or service specified in the processing rule to the rule hierarchy instance;
adding a subjugate application data type node to the application type node for each application data type specified in the processing rule;
adding a subjugate rule node to the application data type node for each combination of application server domain or URL, service and other rule parameters;
creating a session hierarchy instance of sessions for each unique set of virtualization parameters in the IP packet that has a matching rule in the rule hierarchy;
adding a subjugate an application node hierarchically to the session hierarchy instance for a plural of applications;
adding a subjugate application data type node to the application node hierarchically for a plural of application data type specified in the processing rule;
adding a subjugate session node to the application data type node hierarchically for each combination of application server domain or URL and the service; and
adding a subjugate transaction node is added to the session node hierarchically for each application flow.

12. The computer-readable medium recited in claim 11, the steps further comprising:
wherein the virtualization parameters represent the parameters that enable abstraction of authentication processing by their own processing rules and the sessions.
wherein the virtualization parameters are derived from the application flow and comprise of: packet source, source logical network, service provider, enterprise;
wherein the application type includes various L4 to L7 applications, application data type includes data types used in the application PDU, application server domain or URL is the domain of the application server or host being accessed and service is the base path and resource being accessed in the server. These parameters called as session classification parameters are extracted from the IP packets received in the application flow;
wherein a transaction comprises:
Rule summary, a universal unique identifier (UUID) of the application flow, encrypted session parameter token (SPT), protocol authentication state transition details and the associated information;
wherein the SPT is an encrypted token containing UUID, transaction handle, its session handle and a sequence number; thereby SPT provides an association between the application flow and transaction Node;
wherein an SPT is generated along with the transaction and sent to the client or device in the responses to the requests from it.

13. The computer-readable medium recited in claim 11, the steps further comprising:
identifying an application message as an initial request or subsequent request based on the presence of SPT in the application message,
wherein when the message contains an SPT it is treated as subsequent request otherwise treated as new request;
setting the application flow state either as subsequent request or as initial request depending on the result of the previous step.

14. The computer-readable medium recited in claim 11, wherein the steps of adding a session hierarchy instance or nodes to an existing session hierarchy for an initial request comprise:
receiving a message from the gateway;
extracting from the message a set of virtualization parameters;
searching the rule hierarchy of the message using the extracted virtualization parameters for a matching rule node to process the request;
wherein the rule node primarily contains the rule summary of work flow which contains a plurality of protocol authentication stages needed;
identifying the session hierarchy by looking up nodes corresponding to session classification parameters are looked up to find the session node;
adding a new node structure when the session classification parameters are unique and a Session node and a transaction node for the flow; and
updating the transaction node with the rule summary.

15. The computer-readable medium recited in claim 11, wherein the association of application flow and transaction is looked up through content addressing of SPT, the steps comprising:
decrypting the SPT in the response from the client or device;
Validating the constituents of the SPT in the transaction node;
wherein gateway mandates the client or device to send the SPT in the subsequent messages to the gateway;
wherein the transaction node is found and referenced without repetitively looking up into the session hierarchy for the session node and transaction node of the response.

16. The computer-readable medium recited in claim 15, wherein the steps of eliminating replay attacks comprises:
making unique the sequence number parameter in the SPT present in every response that is sent by the gateway by incrementing the value;
invalidating the SPT and dropping the IP packet without processing when the same SPT in the IP packet is used a plural of responses; and
providing valid SPT in the response only when the packet was successfully by the gateway.

17. The computer-readable medium recited in claim 15, wherein the steps of eliminating session hijack comprises:
encrypting the contents of the SPT;
comparing the session classification parameters of the application flow with those of the session upon successful validating the association between the application flow and transaction contained in SPT; and
comparing the virtualization parameters of the application flow with those of the session upon successfully validating the association between the application flow and transaction contained in STP.

18. The computer-readable medium recited in claim 14, wherein based on the protocol authentication workflow in the rule summary of a transaction, the steps of conducting the transaction comprises:
creating a binding upon protocol authentication steps among the client or device, gateway and application server for a given application flow for the client or device;
deleting the transaction; and
storing the bindings virtualization parameters, session parameters and authorization attributes in the gateway securely.

19. The computer-readable medium recited in claim 18, the steps to avoid subsequent requests going through repetitive authentication work flows comprises:
wherein for same authenticated application flow or new application flows the gateway mandates the client or device to send the binding in the message;
creating a new transaction and setting application flow state to initial request and rule look up is performed;
retrieving the binding from gateway;
validating the retrieved binding against all the application flow virtualization parameters and session parameters;
determining if the application flow is for another application or service that is present in the authorization attributes;
issuing another binding for the application flow when the application flow is successfully authorized;
authenticating the application flow through the full authentication flow when the application flow is not authorized when the application flow misses part of authorization attributes or there is no entry of the binding in the binding store; and
updating the binding entry in the binding store by adding the new binding as a child to first binding representing the binding between the client or device and the application server by keeping the binding between the client or device and gateway the same.

20. The computer-readable medium recited in claim 19, the steps further comprising;
performing life cycle management of the bindings and bindings timeout as specified by the authentication session timeout interval;
generate time out events when time out occurs; and
publish generated timeout events

21. An authentication processing system for transparent authentication for permission to access resources and acquire services available on a computer network, comprising:
means for providing a hierarchical model of rule organization and session management for stateful authentication processing in a gateway;
wherein the authentication processing flow processes authentication challenge request and response statefully as per the authentication methodology;
wherein the authentication packet processing rules and sessions are organized, looked up and managed hierarchically;
means for creating a rule hierarchy instance of rules for every unique set of virtualization parameters of a processing;
means for adding a subjugate application type node for each application or service specified in the processing rule to the rule hierarchy instance;
means for adding a subjugate application data type node to the application type node for each application data type specified in the processing rule;
means for adding a subjugate rule node to the application data type node for each combination of application server domain or URL, service and other rule parameters;
means for creating a session hierarchy instance of sessions for each unique set of virtualization parameters in the IP packet that has a matching rule in the rule hierarchy;
means for adding a subjugate application node hierarchically to the session hierarchy instance for each application;
means for adding a subjugate application data type node to the application node hierarchically for each application data type specified in the processing rule;
means for adding a subjugate session node to the application data type node hierarchically for a plural of combinations of application server domain or URL and the application; and
means for adding a subjugate transaction node is added to the session node hierarchically for each application flow.

22. The system of claim 21:
wherein the virtualization parameters represent the parameters that enable abstraction of authentication processing by their own processing rules and the sessions.
wherein the virtualization parameters are derived from the application flow and comprise of: packet source, source logical network, service provider, enterprise;
wherein the application type includes various L4 to L7 applications, application data type includes data types used in the application protocol data unit (PDU), application server domain and service or the base path and resource being accessed in the server;
wherein a transaction comprises:
rule summary, a universal unique identifier (UUID) of the application flow, encrypted session parameter token (SPT), protocol authentication state transition details and associated information;
wherein the SPT is an encrypted token containing UUID, transaction handle, its session handle and a sequence number; thereby SPT provides an association between the application flow and transaction node; and
wherein an SPT is generated along with the transaction and sent to the client/device in the responses to the requests from it.

23. The system of claim 21, further comprising:
means for identifying an application message as an initial request or subsequent request based on the presence of SPT in the application message,
wherein if the message contains SPT it is treated as subsequent request otherwise treated as new request; and
means for setting the application flow state either as subsequent request or as initial request depending on the result of the previous step.

24. The system of claim 1, wherein means for addition of a session hierarchy instance or nodes to an existing session hierarchy for an initial request comprise:
means for receiving a message from the gateway;
means for extracting from the message a set of virtualization parameters;
means for searching the rule hierarchy of the message using the extracted virtualization parameters for a matching rule node to process the request;
wherein the rule node primarily comprises the rule summary of work flow which contains a plurality of protocol authentication stages needed;
means for identifying the session hierarchy by looking up nodes corresponding to session classification parameters are looked up till the session node is found;
means for adding a new node structure when the session classification parameters are unique and a session node and a transaction node for the flow; and
means for updating the transaction node with the rule summary.

25. The system of claim 2, wherein the association of application flow and transaction is looked up through content addressing of SPT, the means comprising:
means for decrypting the SPT in the response from the client or device; and
means for validating the constituents of the SPT in the transaction node;
wherein gateway mandates the client or device to send the SPT in the subsequent messages to the gateway;
wherein the transaction node is found and referenced without repetitively looking up into the session hierarchy for the session node and transaction node of the response.

26. The system of claim 25, wherein the means for eliminating replay attacks comprises:
means for making unique the sequence number parameter in the SPT present in every response that is sent by the gateway by incrementing the value;
means for invalidating the SPT and dropping the IP packet without processing when the same SPT in the IP packet is used a plural of responses; and
means for providing valid SPT in the response only upon the packet was successfully by the gateway.

27. The system of claim 25, wherein the means for eliminating session hijack comprises:
means for encrypting the contents of the SPT;
means for comparing the session classification parameters of the application flow are compared with those of the session upon validating the association between the application flow and transaction through SPT; and
means for comparing the virtualization parameters upon success of the above validation.

28. The system of claim 24, wherein based on the protocol authentication work flow in the rule summary of a transaction, the means for conducting the transaction comprises:
means for creating a binding upon protocol authentication steps among the client or device, gateway and application server for a given application flow the client or device;
means for deleting the transaction; and
means for storing the bindings virtualization parameters, session parameters and authorization attributes in the gateway securely.

29. The system of claim 28, the means for avoiding subsequent requests going through repetitive authentication work flows comprises:
means for the gateway to mandate the client or device to send the binding in the messages for same authenticated application flow or new application flows;
means for creating a new transaction and setting application flow state to initial request and rule look up is performed;
means for retrieving the binding from gateway;
means for validating the retrieved binding against all the application flow virtualization parameters and session parameters;
means for determining if the application flow is for another application or service that is present in the authorization attributes;
means for issuing a binding for the application flow when the application flow is authorized;
means for authenticating the application flow through the full authentication flow when the application flow is not authorized when the application flow misses part of authorization attributes or there is no entry of the binding in the binding store; and
means for updating the binding entry in the binding store by adding the new binding as a child to first binding representing the binding between the client or device and the application server by keeping the binding between the client or device and gateway the same.

30. The system of claim 9, further comprising:
means for performing life cycle management of the bindings and bindings timeout as specified by the authentication session timeout interval;
means for generate time out events when time out occurs; and
means for publish generated timeout events.

31. A method for authenticating a user access request comprising: receiving a message by a gateway from a user over a communication medium, said message indicating said user is requesting access to a protected device; user identity and access charactericts are extracted from the message by said firewall device; user identity and access characterics are authenticated by said gateway by searching the authentication rule database using said user indentity and access characterics; an access key is constructed by said gateway and sent back to user.

32. The method of claim 31, further comprising the step of:
constructing a transaction for book keeping the information gathered and authentication rules used while performing the steps of claim 31.

33. The method of claim 32, wherein said access key contains a reference to the said transaction

34. The method of claim 32, wherein said transaction is indexed hierarchically.

35. The method of claim 31, wherein said authentication rule database is indexed hierarchically.

36. The method of claim 31, wherein said access key comprises the user identity.

37. The method of claim 31, wherein said access key comprises an incrementable sequence number.

38. The method of claim 31, wherein said access key is securely encripted.

39. The method of claim 31, wherein subsequent messages from said user to said gateway contains said access key.

40. The method of claim 31, wherein said gateway creates new access key and send said new access key to user.

41. A computer-readable medium carrying one or more sequences of instructions for transparent authentication for permission to access resources or to acquire services available on a computer network, wherein execution of the one or more sequences of instructions by one or more processors causes the one or more processors to perform the steps of: receiving a message by a gateway from a user over a first communication medium, said message indicating said user is requesting access to a protected device; user identity and access charactericts are extracted from the message by said firewall device; user identity and access characterics are authenticated by said gateway by searching the rule database using said user indentity and access characterics; an access key is constructed by said gateway and sent back to user.

42. The computer-readable medium of claim 41, further comprising the sequence of instructions for:
constructing a transaction for book keeping the information gathered and authentication rules used while performing the steps of claim 31.

43. The computer-readable medium of claim 42, wherein said access key contains a reference to the said transaction

44. The computer-readable medium of claim 42, wherein said transaction is indexed hierarchically.

45. The computer-readable medium of claim 41, wherein said authentication rule database is indexed hierarchically.

46. The computer-readable medium of claim 41, wherein said access key comprises the user identity.

47. The computer-readable medium of claim 41, wherein said access key comprises an incrementable sequence number.

48. The computer-readable medium of claim 41, wherein said access key is securely encripted.

49. The computer-readable medium of claim 41, wherein subsequent messages from said user to said gateway contains said access key.

50. The computer-readable medium of claim 41, wherein said gateway creates new access key and send said new access key to user.

51. An authentication processing system for transparent authentication for permission to access resources or acquire services available on a computer network, comprising: means for receiving a message by a gateway from a user over a first communication medium, means for said message indicating said user is requesting access to a protected device; means for extracting user identity and access charactericts from the message by said firewall device; means for authenticating by said gateway user identity and access characterics by searching the rule database using said user indentity and access characterics; means for constructing an access key by said gateway and means for sending back said access key back to user.

52. The system of claim 51, further comprising:
means for constructing a transaction for book keeping the information gathered and authentication rules used while performing the steps of claim 31.

53. The system of claim 52, wherein said access key contains a reference to the said transaction

54. The system of claim 52, further comprising means for indexing the transactions hierarchically.

55. The system of claim 51, further comprising means for indexing the said authentication rules hierarchically.

56. The system of claim 51, wherein said access key comprises the user identity.

57. The system of claim 51, wherein said access key comprises an incrementable sequence number.

58. The system of claim 51, further comprising means for securely encripting the said access key.

59. The system of claim 51, wherein subsequent messages from said user to said gateway contains said access key.

60. The system of claim 51, further comprising means for the said gateway to create new access key and means to send said new access key to user.
